(19) United States
(12) Patent Application Publication
(10) Pub. No.: US 2008/0015872 A1
(43) Pub. Date: Jan. 17, 2008

(54) METHOD OF PROVIDING SOFTWARE AND A SERVICE USING THE SOFTWARE

(75) Inventor: Frank Schueler, Karlsruhe (DE)

Correspondence Address: DARBY & DARBY P.C., P.O. BOX 770, Church Street Station, New York, NY, 10008-0770, US

(73) Assignee: comBOTS Product GmbH & Co. KG, Karlsruhe (DE)

(21) Appl. No.: 11/457,036

(22) Filed: Jul. 12, 2006

(51) Int. Cl. G06Q 10/00

(52) U.S. Cl. 705/1

(57) ABSTRACT

A method of providing a software and a service using the software to an end user includes offering to the end user the software for installation on an end user device of the end user. The end user is offered a first contract with a first service provider for using the service free of charge for an unlimited period of time. The end user is offered a second contract by a second service provider or merchant for using the service subject to charge. The user is free to shift use of service from the first service provider to the second provider or merchant.

In general, the present invention relates to a method of providing software to end users to acquire the end users as customers of a service using the software. In particular, the present invention relates to a method of providing a communications software to end users to acquire the end users as customers and/or users of a communications service. In more detail the invention relates to a method of providing client software to Internet users to acquire the end users as customers of an Internet-based communications service provided by servers of a service provider and/or a merchant.

### BACKGROUND

Traditionally, in the field of software products and services, there exist various business models and marketing methods for acquiring customers to buy a software and/or to subscribe a service, in particular an Internet service. One widespread and well-known marketing method is the so-called ShareWare business model. This means that a trial version is distributed in advance and without payment, as is common for proprietary software. ShareWare software is typically obtained free of charge, either by downloading from the internet or on magazine cover-disks. A user tries out the program, and thus ShareWare has also been known as DemoWare or TrialWare. The offering of such software and services is accompanied by a request for payment, and the software's distribution license often requires such a payment. Payment is often required once a set period of time (e.g. 30 days) has elapsed after installation.

### SUMMARY OF THE INVENTION

Although the user of ShareWare does not have to pay at once, she or he has to start with a limited software version, the so-called test version, having a restricted scope of functions. Therefore the user cannot discover all the advantages of the software or the service, but can only guess or imagine the full scope of features and advantages. Moreover this limited version is only valid for quite a short time period (e.g. 30 days) whereby the user is forced to hurry through the testing and evaluation. Thus the prior art methods of providing software and services are not appropriate for a lasting impression on the user's interest. Even to a lesser extent is the chance to inspire or enthuse the end user to pay for a full-version software and to become a customer of that service.

As a result of this it would be desirable to have a convenient and more efficient method of providing a software to an end users to make the customers or subscribers of a service using said software.

The present invention provides in an embodiment a method of providing a software and a service using the software to an end user. The method includes: offering to the end user the software for installation on an end user device of the end user; offering to the end user a first contract with a first service provider for using the service free of charge for an unlimited period of time; and offering to the end user a second contract by a second service provider or merchant for using the service subject to charge, wherein the user is free to shift use of service from the first service provider to the second provider or merchant.

The present invention also provides in an embodiment a method

### BRIEF DESCRIPTION OF THE DRAWINGS

In the following description, the present invention is elaborated upon based on exemplary embodiments, with reference to the drawings.

FIG. 1 shows a schematic network diagram illustrating the relationships between users or customers and FriendlyWare™ offering entities;

FIG. 2 shows a schematic diagram depicting a timescale with the course of actions according to the FriendlyWare™ method of the invention;

FIG. 3 shows a flowchart of the inventive method.

### DETAILED DESCRIPTION

In an embodiment, the method according to the present invention may comprise the step of offering a full version software enabling an unlimited use of the service being likewise subject to charge or free of charge.

This method according to the present invention enables the user from the very beginning and without any limitations to enjoy full software and service free of charge. In contrast to the known methods, such as ShareWare marketing, the invention does not restrict the use of the software or the service in terms of time, scope, comfort or the like. In an embodiment the user has just to accept a first contract which is called “Basic Contract”. This Basic Contract immediately allows the user to apply the full version software and to enjoy the full service as long as she or he wants to. If the user is really convinced of the performance, advantages and benefits of the product/service he or she may decide to accept a second contract which is called “Merchant Contract” and which is a full-subscription including the payment for the service. The software as such remains gratis. As this marketing method is a likable approach to promote the service while distributing the software in a user-friendly manner, the invention in an embodiment we call “FriendlyWare™.” The first steps are performed by the first provider who gives the software away and who provides the service free of charge. Moreover the first provider presents to the user a choice or collection of several merchants or further providers from which the user then may select one or even more to be marked as preferred shops, wherein the user may get into a direct one-to-one business relationship which each of the shop providers. The shop providers or merchants need not to be the same providers as those who are providing and operating the service.

Not only from the end user's but also from the provider's and/or merchant's point of view the invention overcomes disadvantages and shortcomings of prior art methods, such as ShareWare, FreeWare or the like. Conventional methods or concepts are based on a single partnership model, i.e. on solely one contract being closed between the end user and a single producer or provider. In contrast to this the new marketing concept of FriendlyWare™ is widened to a multi-partnership platform which enables a first provider to present to the users a comfortable market place comprising several merchants to be chosen after having comprehensively tested the service free of charge. As the users' testing or evaluations of the software does not imply any payment or restriction in scope of time, the first provider does not have to implement respective control devices and processes. The first provider just needs to establish simple user accounts without full subscription, payment and/or billing. And it is noteworthy that all effort for establishing user accounts for full-subscriptions need not to be made until the users have decided to accept the second contract with at least one of the merchants or further providers. From there on it is up to the respective merchant to furnish the service and to make the efforts.

There are many ways of applying the invention to the business of software and/or service marketing. In an embodiment, when the second contract is being accepted by the end user, the method of the present invention is foreseen to comprise the further step of providing the end user by a second service provider and/or by a merchant with at least one of additional software features and/or additional service features. This can be considered as some kind of welcome gift which shall further attract the user and support his or her decision for a full-subscription in giving a heightened sense of well-being. Examples of such additional software and/or service features will later be explained in more detail.

In an embodiment, the end user is offered a third contract for using at least one shop to obtain assets in terms of further software and/or services, the at least one shop being conducted by one of the service providers or merchants. In this context it is advantageous to further offering and accepting the third contract only under the condition that the end user has accepted the first contract. This opens the FriendlyWare™ concept to a shopping platform being fully scalable and controllable by the first provider.

In order to strengthen the control functions and options of the first provider it is advantageous to terminate the first contract only under the condition that the user has terminated the second contract and/or the third contract.

In an embodiment, the method includes offering a communications software to end user to become a customer and/or a user of a communications service, in particular offering a client software to an Internet user to become a customers of an Internet-based communications service provided by servers of the service providers and/or merchant.

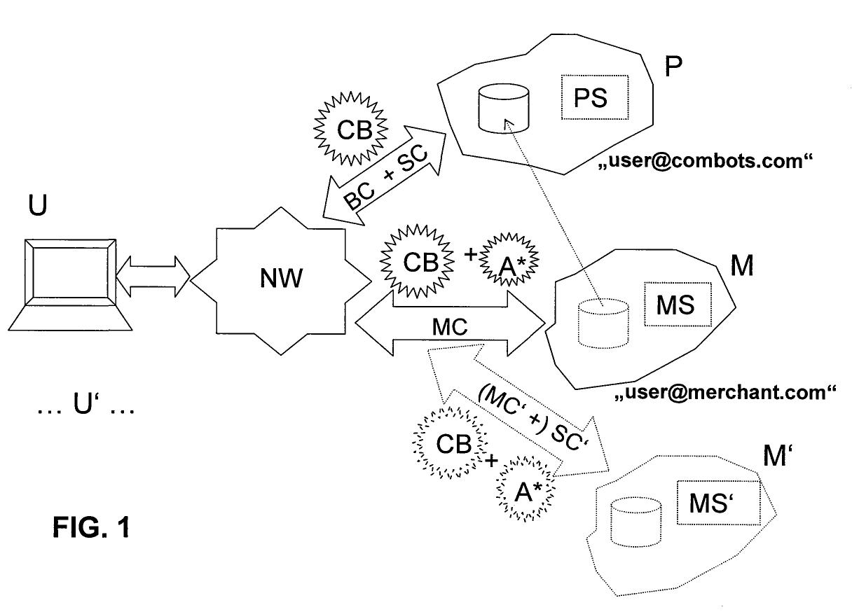

FIG. 1 shows a diagram in form of a schematic drawing of a network architecture illustrating the user access to different providers of software and/or services according to the present invention, i.e. to a new marketing or business method which we call FriendlyWare™. As can be seen from the figure there are several users U . . . U′ having access to a network NW, namely the Internet, to get into touch with software and service providers P or merchants M and M′. An exemplary one of the users is shown, namely a user U having an end user device or terminal, namely a personal computer, to browse the Internet NW. According to a preferred embodiment the user U shall become customer of a service, namely of a communications service CB, which is provided via the Internet by different providers P and/or merchants M or M′. The service CB is for communicating via the Internet among users, e.g. user U communicates with user U′, wherein the users are customers of said service CB and can communicate in a multi-medial and private manner. In particular the user are provided with Software, namely a client software, to be installed on each user terminal and to allow access to the provider's servers and communication platform via the Internet NW. Such a communications platform is elaborated upon in copending published U.S. patent applications, assigned to the assignee of the present applicant, 20050281206, 20050182824, 20040148351 and 20040019629, the entire disclosures of which are hereby incorporated by reference herein. The users who have installed the client software and have become registered customers can fully use the service to interact and communicate with each other.

The client software can be considered to be some small piece of automatically operating software, like a robot. The service and the platform we call “ComBOTS™.” This is also to express a new way of communicating via such clients or robots which are designed to appear on the desktop of each user in form of animated characters or avatars and which we call ComBOTS™ characters. On the user's desktop each ComBOTS™ character is designed to represent one of the other users who are ComBOTS™ communications partners of said user. The service CB comprises and integrates very conveniently many ways of communicating techniques, such as eMail, Instant Messaging, phoning, in particular VoIP (Voice over IP), WindowSharing, FileSharing etc. As shown in FIG. 1 the service CB is not restricted to communications service, but is also covering many other possibilities, in particular Online Shopping which will be explained below in more detail.

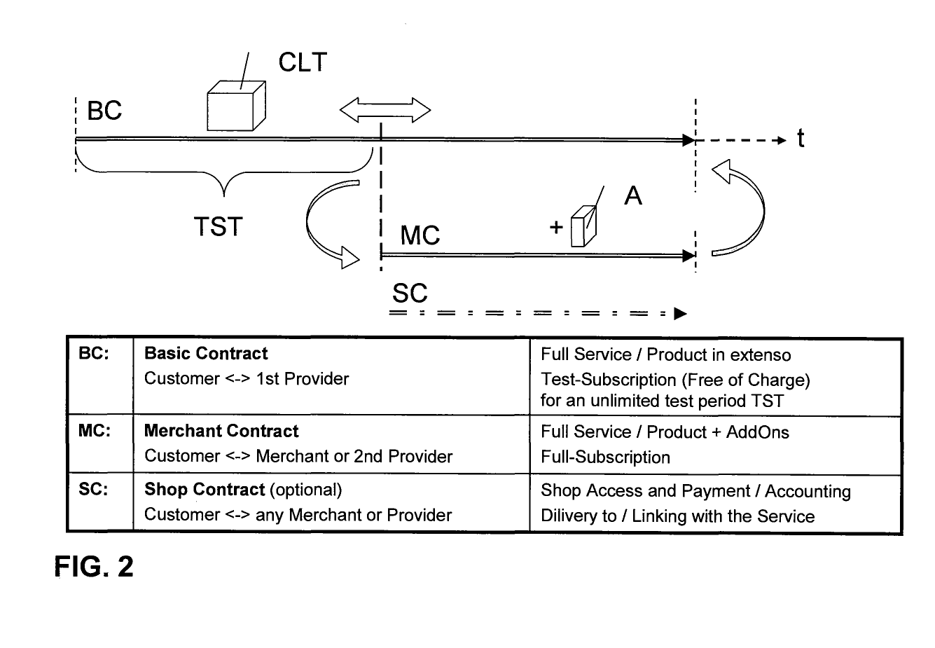

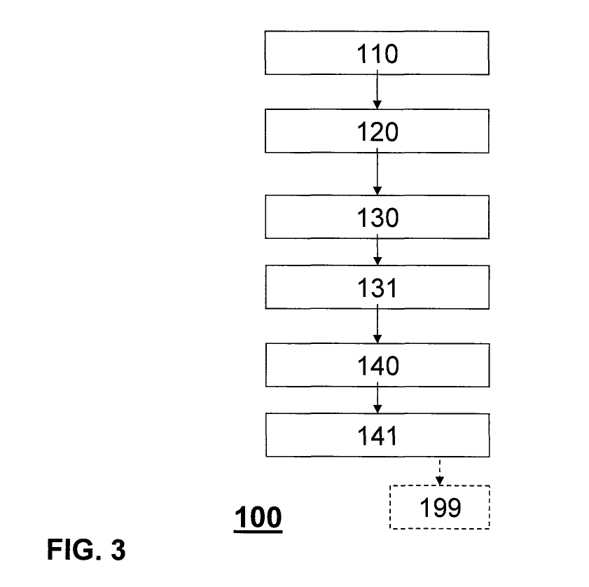

From FIG. 1 it is seen that the user U will get access to at least one provider P and/or to a merchant M providing full use of the ComBOTS™ service. At the very beginning the user U will get first into contact with the provider P who is considered to be the so-called first provider. This may be utilized by the user who visits the website www.combots.com of said first provider P and to download the free-offered client software. Another marketing channel is to send from the provider P what we call ComBOTS™ invitations to the user to attract his or her attention for becoming customer of the ComBOTS™ service. These invitations can be transmitted by eMail or even by postal letter which is sent to the end user. If then the user U will download or even install the offered software, he or she will get full service access to the ComBOTS™ service. The user U only has to give his or her eMail address and will immediately be registered at the first provider P. The user U will then be a new customer having his or her own account and address (e.g. “user@combots.com”). With this identification he or she can easily log-on the system and use the full ComBOTS™ service. From the commercial or even legal point of view the user U is contracting a first contract BC, also called here “Basic Contract”, thus getting free of charge a full access to the P provider's service. In addition to the first contract BC the user U is offered at least one further contract, namely a second contract MC and optionally a third contract SC. The terms and conditions of these contracts and also an overview of the concept can be seen from FIG. 2 whereas the detailed steps of the inventive method become more apparent while looking at FIG. 3.

Therefore in the following description also reference will be made to both FIGS. 2 and 3 thereby disclosing in more detail the new marketing concept we call FriendlyWare™:

In FIG. 2 there is shown a schematic diagram depicting a timescale with the course of actions according to the FriendlyWare™ method. From FIG. 3 a flowchart of the method 100 can be seen to comprise the steps of 110 to 141. In a first step 110 the end user will be offered a full software product, namely the ComBOTS™ client, to be installed on his or her device (e.g. personal computer or mobile radio device). Accordingly in a next step 120 a first contract BC is offered to allow the user to use that client software free of charge. If the user accepts this contract BC which may in an embodiment be called Basic Contract, he or she will immediately have access to a full service provided by the first provider P. The service is free of charge and can be used for an unlimited period of time (see the double-headed arrow in FIG. 2) which may in an embodiment also be called test period TST although having in mind that the user is not burdened with any test restriction. The user is rather invited to test and to learn about the product (client software) and the ComBOTS™ service, wherein he or she can use the full scope of features of both the software and the service as long as he wants to. Thus this is a very generous kind of test subscription.

In a further step 130 and throughout the whole period TST the end user is offered or invited to shift to the second deal, namely to shift to at least one of so-called merchant contracts MC. These merchant contracts MC (also see MC′ in FIG. 1) are full-subscriptions provided by further providers or merchants (see M or M′ in FIG. 1) to which the user is supposed to pay a service fee, because each the subscription will now be charged. Thus the further providers or merchants can be considered to make their money with providing the service as such. In contrast to this the first provider (see P in FIG. 1) who does not charge the service just makes his money with acting as an agent or broker, i.e. by receiving some revenue shares from all the successfully recommended merchants. The end user U who starts with the first provider P is free to shift at any time that use of service CB from this first service provider P to one or more of that further providers and/or merchants. Therefore the Basic Contract BC constitutes a central marketing platform for user friendly product testing and for introducing the commercial deals with the real service providers or merchants. Therefore the first provider's P interest is mainly to broker the deals (via Basic Contract BS) whereas the further providers' or merchants' interest is more to profit from the use of the service CB and/or from offering additional services (via Merchant Contracts MC, MC′ and/or Shopping Contracts SC).

Therefore in a following step 131 the user U is then provided by the selected second service provider and/or merchant M with at least one of additional software features A and/or additional service features A* as can be seen in FIG. 1. These add-ons are e.g. to extend the client software in terms of functions, design and/or rights, e.g. access rights to get content from closed user-groups or the like. Those add-ons may also be related to the service, i.e. by improving the customer's support or customer care such as giving him or her a toll-free hotline or the like. The add-ons A* may be any gift or bonus to show the user that he or her was doing right when contracting the merchant deal MC. In particular the add-ons comprise further webspace to be used within the communications service to let buffer or store user data, such as messages, pictures, photos, audio or video files etc. Or the add-on can be the use of store & forward connections instead of pure peer-to-peer connection.

As mentioned above the end user can be offered a third contract SC which may in an embodiment be called ShoppingContract. This is performed in a step 140 for offering to the user access to at least one Online Shop PS or MS (either provided by a service provider or conducted by a merchant) to let the user obtain from there various types of assets, such as further software, services, rights and/or permissions. In a further step 141 the third contract SC, which may in an embodiment be called Shop Contract, is only accepted and brought into force if the condition is met, that the end user U has accepted the first contract BC, i.e. the Basic Contract. Thus the Basic Contract is also the basis or platform for accepting Shop Contracts SC.

If the provider or merchant wants to terminate this Basic Contract BC in a step 199 he can terminate this first contract BC only under the condition that the user U has terminated the second contract MC and/or the third contract SC. Thus the further contracts MC and SC which are pure customer relationships are both depending on the first contract BC. And it is assured that this contract BC is not terminated without having closed these depended customer relationships which are e.g. so-called B2C relationships (business-to-consumer) or C2B relationships (consumer-to-business).

As mentioned above the method 100 may be realized by offering in step 110 a communications software to an end user to become a customer and/or a user of a communications service. In particular there is offered a client software CLT to an Internet user U to become a customers of an Internet-based communications service CB provided by servers of the service providers P and/or merchant M.

The term “service provider” may define any legal entity, such as person, company or organisation, having technical equipment, in particular servers, to provide via a Network, in particular the Internet, any kind of service.

“Service” may mean any kind of service, in particular any communications service, such as messaging service, phone service and the like. It also shall mean any data and/or information service, such as database service, hosting service, search service, webspace service etc. Also other services can be meant, such as online portal services, consultancy services and the like. In particular those services are preferably offered which can be booked or subscribed.

The term “FriendlyWare” may be understood to encompass a new way of offering and providing software and/or services to users as explained in the above description of the invention.

The present invention has been described based on exemplary embodiments, but is not to be interpreted as being limited to those embodiments. Rather the invention is defined by the full scope of the appended claims, including equivalents thereof.

What is claimed is:

1. A method of providing a software and a service using the software to an end user, the method comprising:
offering to the end user the software for installation on an end user device of the end user;
offering to the end user a first contract with a first service provider for using the service free of charge for an unlimited period of time; and
offering to the end user a second contract by a second service provider or merchant for using the service subject to charge, wherein the user is free to shift use of service from the first service provider to the second provider or merchant.

2. The method as recited in claim 1 wherein the user is free to shift use of service from the first service provider to the second provider or merchant at any time.

3. The method as recited in claim 1 wherein the software is a full version software enabling an unlimited use of the service and the offering the end user the software for installation is subject to charge.

4. The method as recited in claim 1 wherein the software is a full version software enabling an unlimited use of the service and the offering the end user the software for installation is free of charge.

5. The method as recited in claim 1 further comprising, when the second contract has been accepted by the end user, providing the end user, by the second service provider or merchant, with at least one of an additional software feature and an additional service feature.

6. The method as recited in claim 1 further comprising offering to the end user a third contract for using at least one shop to obtain at least one of further software and services.

7. The method as recited in claim 6 further comprising conducting the at least one shop by at least one of the first service provider and the second service provider or merchant.

8. The method as recited in claim 1 further comprising offering to the end user, only when the end user has accepted the first contract, a third contract for using at least one shop to obtain at least one of further software and services.

9. The method as recited in claim 1 further comprising terminating the first contract only when the user has terminated the second contract.

10. The method as recited in claim 6 further comprising terminating the first contract only when the user has terminated at least one of the second contract and the third contract.

11. The method as recited in claim 1 further comprising offering a communications software to the end user so as acquire the end user as a customer or user of a communications service.

12. The method as recited in claim 11 wherein the end user is an Internet user, the communications software is a client software, and the communications service is an Internet-based communications service provided by a respective server of at least one of the first service provider and the second service provider or merchant.
